(19) United States
(12) Patent Application Publication
(10) Pub. No.: US 2026/0279605 A1
(43) Pub. Date: Sep. 17, 2026

(54) MOLTEN SALT REACTOR AND MOLTEN SALT REACTOR SYSTEM

(71) Applicant: IUCF-HYU (INDUSTRY-UNIVERSITY COOPERATION FOUNDATION HANYANG, Seoul (KR)

(72) Inventors: Sung Joong KIM, Seoul (KR); Jae Hyung PARK, Seoul (KR); Jihun IM, Seoul (KR); Juhyeong LEE, Seoul (KR); Won Jun CHOI, Seoul (KR); Yun Sik CHO, Seoul (KR); Yong Hee KIM, Dejeon (KR); Tae Suk OH, Daejeon (KR); Eun Hyung LEE, Daejeon (KR)

(73) Assignee: IUCF-HYU (INDUSTRY-UNIVERSITY COOPERATION FOUNDATION HANYANG, Seoul (KR)

(21) Appl. No.: 19/530,721

(22) Filed: Feb. 5, 2026

Related U.S. Application Data
(63) Continuation of application No. PCT/KR2024/012753, filed on Aug. 27, 2024.

(30) Foreign Application Priority Data
Aug. 29, 2023 (KR) 10-2023-0113942

(51) Int. Cl. G21C 3/54; G21C 1/02; G21C 7/103; G21C 9/02; G21C 13/00; G21C 19/303; G21C 19/32

(52) U.S. Cl. CPC G21C 3/54; G21C 1/02; G21C 7/103; G21C 9/02; G21C 13/00; G21C 19/303; G21C 19/32

(57) ABSTRACT

Provided is a molten salt reactor including: a reactor vessel; a containment vessel configured to surround the reactor vessel; and an inert salt provided outside the reactor vessel and inside the containment vessel, in which the inert salt is in a liquid phase or a solid phase.

### CROSS REFERENCE TO RELATED APPLICATIONS

This application is a Bypass continuation of International Application No. PCT/KR2024/012753, filed on Aug. 27, 2024, which claims priority from Korean Application No. 10-2023-0113942, filed on Aug. 29, 2023, the contents of all of which are incorporated herein by reference in their entirety.

### TECHNICAL FIELD

The present invention relates to a molten salt reactor and a molten salt reactor system, and more specifically, to a molten salt reactor and a molten salt reactor system, which enable multi-purpose, long-term, and long-lifetime operation using one system.

### BACKGROUND ART

A molten salt reactor (MSR) may refer to a reactor in which a nuclear fuel is melted together with a coolant salt and flows in a reactor system in a liquid state, unlike a commercial light water reactor using a solid nuclear fuel. Accordingly, the molten salt reactor may exhibit excellent inherent safety, such as a strong negative feedback effect due to relatively large thermal expansion and a large safety margin even at a low pressure. In particular, since the molten salt reactor has a high boiling point in a low pressurized atmosphere or a non-pressurized atmosphere, high-temperature operation is possible due to a high safety margin, and accordingly, productivity may be excellent.

Typically, the molten salt reactor may be operated at 600° C. to 750° C. Thus, the molten salt reactor may have high hydrogen production efficiency by utilizing high-temperature water electrolysis. Furthermore, the molten salt reactor may be used as a heat source with high industrial value.

In 2001, the molten salt reactor has been selected as one of the future reactor technologies at the Generation IV International Forum (GIF) In the United States, Japan, China, Denmark, and other countries, advanced reactor technologies, including large modular, small modular, marine, and land-based reactors, are actively being developed with reference to the reactor design of the project conducted at Oak Ridge National Laboratory in the 1960s.

Conventionally, the concept has been proposed that use thorium, low enriched uranium, spent nuclear fuel extraction, and nuclear weapon decomposition fuel as nuclear fuel in the molten salt reactor. Nuclear fuel materials used in the molten salt reactor may be combined in various ways, such as binary and ternary mixtures of chlorides and fluorides. In the case of the molten salt reactor, since the performance varies depending on a mixing ratio of the nuclear fuel materials, various molten salt reactor concepts have been proposed.

For example, Korean Patent Registration Publication No. 10-1717942 discloses a technology for a reactor including a small modular reactor core, comprising: a nuclear fuel assembly including a plurality of nuclear fuel elements in which a fission chain reaction occurs; a molten salt coolant disposed between the nuclear fuel elements to absorb energy released by the fission chain reaction and including a molten salt component; and a reflector disposed to surround an outer wall of the nuclear fuel assembly and configured to reduce leakage of neutrons generated from the nuclear fuel assembly, wherein the molten salt coolant includes a nuclear fuel component of LiF—BeF₂—ThF₄—UF₄, the LiF is 15 to 25 parts by weight, the BeF₂ is 3 to 13 parts by weight, the ThF₄ is 31 to 41 parts by weight, and the UF₄ is 31 to 41 parts by weight, and the reactor core is designed to be set to a critical state in which an effective multiplication factor is 1 or more by the molten salt coolant including the nuclear fuel component in a subcritical state, and is designed to be set to a subcritical state in which an effective multiplication factor is less than 1 as the molten salt coolant leaks in the event of a coolant loss accident in the critical state.

The molten salt reactors are expected to be commercialized in the relatively near future, and empirical experiments are currently underway in some countries.

Currently, molten salt reactors that are being commercialized and demonstrated include Seaborg's marine-floating molten salt reactor in Denmark, Terrestrial Energy's IMSR in Canada, and China's TMSR. Candidates of the molten salt reactor system include thorium reactors using a thorium-uranium (Th—U) nuclear fuel cycle. The thorium reactors use fission in a thermal neutron spectrum. Conversely, the concept of a molten salt fast reactor utilizing the fast neutron spectrum has also been proposed according to advantages such as breeding efficiency and reduction of radioactive waste, and examples thereof include the molten chloride fast reactor (MCFR) of TerraPower in the United States and the molten salt fast reactor (MSFR) of CNRS in France.

However, in the conventional molten salt reactor, high safety and productivity may be obtained according to the characteristics of the nuclear fuel flowing through the reactor system in the form of a molten salt together with a coolant salt, but there is a need for a method capable of overcoming the problems to be described below.

A first problem of the related art is that the fission occurs in a reactor core region including a material used as a nuclear fuel, for example, thorium or uranium, and thus other nuclides or fission products according to a nuclear reaction may be generated in a nuclear fuel-coolant molten salt. When the thermal neutron spectrum is used, a real-time reprocess is required, which may violate the Nuclear Non-Proliferation Treaty. Meanwhile, even when the fast neutron spectrum is used, an insoluble fission product may be generated, which may be a factor that impairs the physical stability of the reactor. In addition, when the fission product is adsorbed to some structures, for example, an intermediate heat exchanger, local hydrothermal performance may be significantly reduced and material integrity may deteriorate.

A second problem of the related art is that it is difficult to apply a molten salt circulation pump due to high temperature, high radioactivity, and high corrosiveness of an environment in the reactor system of the molten salt reactor. The high-temperature molten salt may have strong corrosiveness to a metal material, and may have a high radiation environment due to the nuclear material and the fission product. Accordingly, it may be difficult to guarantee long-term operation of the circulation pump that is mainly used in the existing nuclear power industry. The performance deterioration or failure of the circulation pump not only deteriorates the performance of the reactor, but may also cause a nuclear accident due to rapid transition. In addition, radioactive materials may leak through a connection part of the circulation pump. In other words, the development of the circulation pump in the molten salt reactor may impose a significant technical burden and may cause high costs.

A third problem of the related art is that graphite is used as a moderator in the reactor when a low-speed spectrum is applied, and the lifespan of graphite is short compared to the lifespan of the reactor. This may mean that graphite is high-level radioactive waste. In addition, graphite needs to be manufactured in the form of a rod and installed in a plurality of cores, and thus circulation of the molten salt may be hindered, and accordingly, a high-performance pump may be required. In the case of applying a fast spectrum, it is technically difficult to implement because a device for controlling nuclear reactivity of the reactor core is essential. In other words, the device for controlling nuclear reactivity is required, whereas since the device for controlling nuclear reactivity accompanies a problem of forming a flow and deteriorating circulation, the performance of the molten salt reactor may be deteriorated. Accordingly, there is a need for a method capable of greatly reducing the graphite moderator.

A fourth problem of the related art is that radioactive waste of the molten salt reactor may be significantly reduced compared to the existing commercial light water reactor, but when the graphite moderator is aside in a low-speed spectrum, significant radioactive waste is generated if a high combustion degree of the reactor core is not achieved. In addition, when a large amount of radioactive waste is generated relative to a degree of combustion and frequent refueling is required, economic viability is impaired. Accordingly, it is required to achieve a high degree of combustion.

A fifth problem of the related art is that decay heat is continuously generated even when the reactor is normally stopped in the event of an abnormal operation or an accident. The molten salt reactor may have a long response time depending on inherent safety and high safety margin. However, when the decay heat is sufficiently removed and the cooling performance is not guaranteed, it may lead to molten salt boiling. Accordingly, leakage of radioactive materials may increase. Therefore, a freeze plug and an emergency discharge tank are used in a plurality of molten salt reactors, and a core safety system for actively or passively discharging and cooling a nuclear fuel-coolant molten salt is used. However, this not only requires one or more additional penetration parts on a lower portion of a reactor vessel, but may also require excessive lower installation space relative to output. Accordingly, there is a need for a molten salt reactor system capable of continuously and safely removing the decay heat.

A sixth problem of the related art is that materials of the structure in the reactor system, such as the reactor vessel and the intermediate heat exchanger, are always exposed to high temperature, high radioactivity, and high corrosive environments. Even when structural integrity such as mechanical strength is secured, unintended compounds may be generated through chemical reactions in the reactor system due to corrosion and deterioration. Alternatively, material corrosion and deterioration may continue locally, and accordingly, material integrity may be impaired. In other words, there is a need for a corrosion-resistant material capable of minimizing an effect of the compound and securing material integrity.

### DISCLOSURE

### Technical Problem

The technical problem to be solved by the present invention is to provide a system capable of separating insoluble fission products without circulating in a reactor system including a reactor core and an intermediate heat exchanger during a normal operation, that is, a molten salt reactor and a molten salt reactor system capable of removing an insoluble fission product gas, a noble metal, and the like.

Another technical problem to be solved by the present invention is to provide a molten salt reactor and a molten salt reactor system, capable of performing a normal operation by forming stable circulation even after removing a circulation pump from a reactor system.

Still another technical problem to be solved by the present invention is to provide a molten salt reactor and a molten salt reactor system, capable of improving circulation performance and maintaining a stable state by including the same in an operation logic circuit.

Still another technical problem to be solved by the present invention is to provide a molten salt reactor and a molten salt reactor system, which reduce factors that may interfere with circulation of a system from which a circulation pump is excluded, and include a reactor core control technology having excellent performance.

Still another technical problem to be solved by the present invention is to provide a molten salt reactor and a molten salt reactor system, capable of achieving a long lifespan by enabling a stable operation for a long period of time.

Still another technical problem to be solved by the present invention is to provide a molten salt reactor and a molten salt reactor system, capable of safely removing decay heat without releasing radioactive materials into an environment even when an abnormal operation or accident occurs.

Still another technical problem to be solved by the present invention is to provide a molten salt reactor and a molten salt reactor system, in which a technique of applying a base material that reduces long-term corrosion, a base material that maintains long-term material integrity, a coating material, or a corrosion-resistant material to structural materials applied to a reactor vessel, an intermediate heat exchanger, and the like.

Still another technical problem to be solved by the present invention is to provide a molten salt reactor and a molten salt reactor system, which may be connected to a system requiring low-carbon and high-temperature heat sources, such as power generation, district heating, seawater desalination, hydrogen production, and process heat source, and may be practically multipurpose.

The technical problems to be solved by the present invention are not limited to those described above.

### Technical Solution

To solve the above technical problems, the present invention provides a molten salt reactor.

According to one embodiment, a molten salt reactor may include: a reactor vessel; a containment vessel configured to surround the reactor vessel; and an inert salt provided outside the reactor vessel and inside the containment vessel, in which the inert salt may be in a liquid phase or a solid phase.

According to one embodiment, the molten salt reactor may further include a reactor system provided inside the reactor vessel, in which the reactor system may include at least one unit of a reactor core, a riser, an intermediate heat exchanger high-temperature side, or a downcomer, and a heat generation mechanism of the reactor core includes fission performed by a fast neutron spectrum.

According to one embodiment, the containment vessel may have an internal temperature that gradually decreases in a direction radially away from a center thereof, the inert salt in the containment vessel may form a thermally insulating solid layer on an inner wall of the containment vessel, and may be converted into a liquid phase in an event of an accident, and the inert salt may dilute a nuclear fuel-coolant salt when the inert salt is discharged from the reactor vessel, and may be used in a thermal energy storage device of sodium chloride-magnesium chloride (NaCl—MgCl₂), lithium chloride-potassium chloride (LiCl—KCl), lithium chloride-rubidium chloride (LiCl—RbCl), potassium chloride-magnesium chloride (KCl—MgCl₂), sodium chloride-potassium chloride-magnesium chloride (NaCl—KCl—MgCl₂), lithium chloride-potassium chloride-magnesium chloride (LiCl—KCl—MgCl₂), potassium fluoride-zirconium fluoride (KF—ZrF₄), sodium fluoride-sodium fluoroborate (NaF—NaBF₄), potassium fluoride-potassium fluoride (KF—KBF₄), rubidium fluoride-rubidium fluoride (RbF—RbBF₄), or lithium fluoride-sodium fluoride-potassium fluoride (LiF—NaF—KF).

According to one embodiment, the molten salt reactor may further include: a helium injector provided on a lower portion of the reactor vessel or on the riser and configured to inject helium into the reactor vessel; and an off-gas system provided on an upper portion of the reactor vessel and configured to discharge the helium in the reactor vessel, in which the off-gas system may discharge at least one of helium, gas, and a volatile fission product injected through the helium injector.

According to one embodiment, the molten salt reactor may further include a drum-type reactivity controller provided inside the reactor system and outside the reactor core, in which the drum-type reactivity controller may control circulation and reactivity of the reactor system without interfering with a flow in the reactor core and the riser, and may be operated in a way of passively or actively suppressing fission according to power interruption.

According to one embodiment, the circulation and the reactivity of the reactor system may be controlled by using an injection amount of the helium provided by the helium injector or rotation of the drum-type reactivity controller as a control variable.

According to one embodiment, the control of the circulation and the reactivity of the reactor system may include at least one of: a first control of rotating at least some of absorber pads of the drum-type reactivity controller such that the absorber pads are directed toward the reactor core; or a second control of maintaining the injection amount of the helium provided by the helium injector to increase or decrease for a predetermined period of time.

According to one embodiment, an upper portion of the reactor vessel or the intermediate heat exchanger may be provided in an assembly type for separation, mounting, installation, inspection, or replacement, and the intermediate heat exchanger may be a shell and helical-coil tube heat exchanger or a printed circuit heat exchanger.

According to one embodiment, the molten salt reactor may further include: an inlet through which external air is introduced into the containment vessel; and an outlet through which the air inside the containment vessel is discharged to an outside, in which the inlet and the outlet may be closed during a normal operation, and may be passively or actively opened according to power interruption, and the outlet may be located higher than the inlet from a bottom surface of the containment vessel.

According to one embodiment, the molten salt reactor may include a structure having corrosion resistance and integrity, which is provided on a molten salt contact surface between the containment vessel and an inside of the containment vessel, an inside of the reactor vessel may be operated at a low pressure of less than 10 atmospheres, and a nuclear fuel may be provided inside the reactor vessel, in which the nuclear fuel may include low enriched uranium (LEU) having a uranium-235 enrichment level of less than 20%.

According to one embodiment, a working fluid of the reactor system may include a molten salt, the molten salt may include sodium chloride-uranium trichloride (NaCl—UCl₃), potassium chloride-uranium chloride (KCl—UCl₃), or actinide, an upper space of the reactor vessel in which the molten salt is not present may include a gas that chemically non-reacts with the molten salt, and the chemically non-reacting gas may include at least one of helium (He), argon (Ar), krypton (Kr), xenon (Xe), carbon dioxide (CO₂), or nitrogen (N₂).

According to one embodiment, the reactor core may have a long lifespan with a long term of 20 years or longer without online-reprocessing and without addition of additional nuclear fuel during an operation.

To solve the above technical problems, the present invention provides a molten salt reactor system.

According to one embodiment, the molten salt reactor system including the above-described molten salt reactor, in which the molten salt reactor system may further include: a thermal energy storage system configured to supply thermal energy to a production system by receiving heat from a reactor system, and in which the thermal energy storage system may include: an intermediate heat exchanger low-temperature side configured to receive the heat from an intermediate heat exchanger high-temperature side of the reactor system inside the reactor vessel; a thermal energy storage tank configured to store the thermal energy by moving a molten salt that is heated while passing through the intermediate heat exchanger low-temperature side; and a production heat exchanger configured to transfer the thermal energy to an application requiring a high-temperature heat source.

According to one embodiment, the thermal energy storage system may include an inert salt not including a nuclear material, and the inert salt may be used in a thermal energy storage device of sodium chloride-magnesium chloride (NaCl—MgCl₂), lithium chloride-potassium chloride (LiCl—KCl), lithium chloride-rubidium chloride (LiCl—RbCl), potassium chloride-magnesium chloride (KCl—MgCl₂), sodium chloride-potassium chloride-magnesium chloride (NaCl—KCl—MgCl₂), lithium chloride-potassium chloride-magnesium chloride (LiCl—KCl—MgCl₂), potassium fluoride-zirconium fluoride (KF—ZrF₄), sodium fluoride-sodium fluoroborate (NaF—NaBF₄), potassium fluoride-potassium fluoride (KF—KBF₄), rubidium fluoride-rubidium fluoride (RbF—RbBF₄), or lithium fluoride-sodium fluoride-potassium fluoride (LiF—NaF—KF).

According to one embodiment, in the molten salt reactor system, a flow in the thermal energy storage system may be adjusted according to energy demand, and the thermal energy may be supplied from the thermal energy storage system to the production system through the production heat exchanger.

According to one embodiment, the application may include at least one of power production, district heating, seawater desalination, hydrogen production, or a process heat source, which requires the high-temperature heat source.

To solve the above technical problems, the present invention provides a molten salt reactor structure.

According to one embodiment, the molten salt reactor structure may include the above-described molten salt reactor, in which a surrounding environment of the molten salt reactor may be subjected to an ambient pressure or below with an atmospheric atmosphere, and the ambient pressure or below may include non-pressurization.

According to one embodiment, the molten salt reactor system may not use a neutron spectrum, a chlorine-based salt, and a pump, but may provide high power output.

According to one embodiment, the molten salt reactor system may inject helium in the form of bubbles at a bottom surface of the reactor vessel, a reactor core outlet, or a riser. As helium is injected in the form of bubbles, insoluble fission products, mainly gases and noble metals, may be absorbed into the helium bubbles or or adsorbed onto a surface thereof and transported to a boundary surface of an upper portion thereof. When the bubbles burst at the boundary surface, the insoluble fission products are guided by a first guide part and a second guide part of the present application and accommodated in a specific space, thereby enabling easy management.

According to one embodiment, the molten salt reactor system has a relatively high pressure drop due to a relatively high density of the working fluid of the molten salt reactor, but a temperature difference between the inlet and outlet of the reactor core is very large at a level of 100° C. to 150° C., so that buoyancy due to a large density difference may be expected. In addition, an additional driving force may be obtained according to the injection of a helium gas. However, in order to achieve high power output, a height may increase. Accordingly, the molten salt reactor system may form circulation even after excluding the circulation pump from the reactor system.

According to one embodiment, the circulation in the reactor system of the molten salt reactor system may be induced by helium injection and natural circulation according to a temperature change. Since the working fluid in the reactor system is a nuclear fuel-coolant mixed molten salt, the circulation may have a significant effect on reactor physics and thermal output. Accordingly, the injection amount of helium may be measured through the temperature and flow rate information, and the injection amount of helium may be used as a control variable for maintaining reactivity as well as nuclear-physical and thermo-hydraulic normal operation ranges. Further, this may be incorporated into an operation logic circuit to maintain a stable normal operation state.

According to one embodiment, the molten salt reactor system may use a fast neutron spectrum, and accordingly, a graphite moderator may be excluded, and a reactor core structure may be simplified. However, a separate device may be required for reactivity control, and according to the present application to solve the problem, the molten salt reactor system may include a drum-type reactivity controller installed outside the reactor core. Thus, it is possible to eliminate pressure-drop factors of a reactor core part and ensure excellent reactor core control performance.

According to one embodiment, the molten salt reactor system may use sodium chloride-uranium trichloride (NaCl—UCl₃) or potassium chloride-uranium chloride (KCl—UCl₃) as a working fluid in the reactor system. More specifically, sodium chloride:uranium trichloride (NaCl:UCl₃) may be used in a molar ratio of 67:33, and potassium chloride:uranium trichloride (KCl:UCl₃) may be used in a molar ratio of 47:53. However, the present invention is not limited thereto, and the above-described molar ratios may vary depending on the design, operation condition, and operation time.

According to one embodiment, the molten salt reactor system may include, as passive safety systems, a reactor vessel through which a working fluid circulates; an inert salt liquid layer and an outermost solid layer surrounding the reactor vessel; a containment vessel surrounding the reactor vessel; and an external air system passively opened and closed such that external air may be introduced to and cool an outer wall of the containment vessel in the event of an accident. External air may serve as a final heat sink, thereby enabling safely removal of decay heat.

According to one embodiment, the molten salt reactor system may utilize a metal material having a high content of nickel (Ni), which does not have a high chromium (Cr) content and has high corrosion resistance in a chlorine-based molten salt, as a base material. In addition, in order to prevent corrosion of the base material, a large-area coating technique may be used to coat a material such as zirconium nitride (ZrN), chromium oxide (Cr₂O₃), yttrium oxide (Y₂O₃), or the like, thereby improving corrosion resistance.

According to one embodiment, the molten salt reactor system may include: a reactor module including a reactor vessel surrounding a reactor system (primary system) including a reactor core, a riser, an intermediate heat exchanger high-temperature side, or a downcomer, and a containment vessel filled with a liquid and solid inert salt present outside the reactor vessel; a thermal energy storage system (secondary system) including an intermediate heat exchanger tube side, a thermal energy storage, and a production heat exchanger for transferring heat from a regenerator to a tertiary system used for production, such as power generation, district heating, seawater desalination, hydrogen production, and process heat source; and a production system (tertiary system) including devices required for the production. The reactor system stores thermal energy in the regenerator of the secondary system, so that the energy may be received from the production system as needed and used for the production. Accordingly, a load-following operation and operational flexibility may be secured, and tritium and radioactive materials that may be generated in the reactor system may be completely separated from the production system. In addition, since a separate regenerator is provided in the thermal energy storage system and there is no separate restriction on the production system, the thermal energy storage system may be used for multiple purposes.

### Advantageous Effects

According to the embodiment of the present application, it is possible to provide is a molten salt reactor and a molten salt reactor system including the molten salt reactor, in which the molten salt reactor includes: a reactor vessel; a containment vessel configured to surround the reactor vessel; and an inert salt provided outside the reactor vessel and inside the containment vessel, in which the inert salt is in a liquid phase or a solid phase.

According to one embodiment of the present application, the molten salt reactor system may simplify the system. More specifically, the molten salt reactor system may simplify the system by removing the reactor system circulation pump. In addition, the molten salt reactor system may have a size in which a height thereof is reduced by removing a freeze plug and an emergency discharge tank, and may simplify the system by removing a connector. That is, since the molten salt reactor system may simplify the system, the manufacturability thereof may be improved, is advantageous to apply the passive safety system, and system reliability may be enhanced.

According to one embodiment of the present application, the molten salt reactor system may reduce radioactive waste. Since the molten salt reactor system uses a fast spectrum, high-level waste may be minimized by reducing or excluding periodic replacement of the graphite moderator. In addition, the molten salt reactor system may enable high-combustion, long-term, and long-lifetime operation, thereby minimizing radioactive waste.

According to one embodiment of the present application, the molten salt reactor system may be stably operated. In addition, the molten salt reactor system may remove insoluble fission products during a normal operation, thereby minimizing nuclear-physical instability. In addition, the molten salt reactor system may minimize instable flow and accidents due to malfunction and failure of the circulation pump by using the natural circulation. In addition, the molten salt reactor system may maintain a stable operation condition by adjusting the injection amount of helium provided by the helium injector. In addition, the molten salt reactor system has a thermal energy storage system between the reactor system and the production system and flexibly adjusts conditions of the thermal energy storage system, thereby enhanced the flexibility of operation and production.

According to one embodiment of the present application, the molten salt reactor system may have enhanced safety and enhanced reliability. The molten salt reactor system may have high safety and improve the reliability of a safety system by applying a passively operating safety system in addition to the inherent safety of the molten salt reactor. The molten salt reactor system may use the final heat sink as an atmosphere (external air), thereby maximizing site selection flexibility. Accordingly, the molten salt reactor system may have enhanced social acceptability. In particular, since a temperature difference between the system and the atmosphere is very large, the molten salt reactor system may be applied regardless of climate (tropical, subtropical, temperate, cold, or polar) through major heat removal mechanisms.

According to one embodiment of the present application, the molten salt reactor system may exclude the violation of the nuclear diffusion prohibition treaty. The molten salt reactor system may minimize the violation of the nuclear diffusion prohibition treaty by using low enriched uranium and a fast spectrum. In particular, since the molten salt reactor system is not subjected to online-reprocessing during operation, effects such as operation convenience, radioactive material management convenience, and system simplification may be obtained.

According to one embodiment of the present application, the molten salt reactor system may be used for multiple purposes. The molten salt reactor system may obtain a high-temperature heat source from the thermal energy storage system and use the high-temperature heat source for multiple purposes such as power generation, district heating, seawater desalination, hydrogen production, and a process heat source. That is, since the molten salt reactor system may be used as one system in various ways, a utility value thereof may be excellent.

### DESCRIPTION OF DRAWINGS

FIG. 1 is a view for explaining a molten salt reactor according to an embodiment of the present application.

FIG. 2 is a view for explaining in more detail the molten salt reactor according to the embodiment of the present application.

FIG. 3 is a view for explaining a helium injector of the molten salt reactor according to the embodiment of the present application.

FIG. 4 is a view for explaining an off-gas system in the molten salt reactor according to the embodiment of the present invention.

FIG. 5 is a view for explaining in more detail the off-gas system according to the embodiment of the present application.

FIG. 6 is a view for explaining a comparison between the off-gas system and a conventional system according to the embodiment of the present application.

FIG. 7 is a view for explaining a drum-type reactivity controller according to the embodiment of the present application.

FIG. 8 is a view for explaining an inert salt of the molten salt reactor according to the embodiment of the present application.

FIG. 9 is a view for explaining an inlet and an outlet of the molten salt reactor according to the embodiment of the present application.

FIG. 10 is a view for explaining a molten salt reactor system according to the embodiment of the present application.

FIG. 11 is a view for explaining a control method of the molten salt reactor system according to the embodiment of the present application.

FIG. 12 is a view for explaining a molten salt reactor structure according to the embodiment of the present application.

FIG. 13 is a graph of evaluating a long-term and long-lifetime operability of a molten salt reactor by computational analysis according to an experimental example of the present application.

FIG. 14 is a graph of evaluating safety in the event of an accident of the molten salt reactor according to the experimental example of the present application.

### MODE FOR INVENTION

Hereinafter, preferred embodiments of the present invention will be described in detail with reference to the accompanying drawings. However, the present invention may be embodied in different forms and should not be construed as limited to the embodiments set forth herein. Rather, the embodiments introduced herein are provided so that the disclosed contents may be thorough and complete and the spirit of the present invention may be sufficiently conveyed to those skilled in the art.

In the present specification, it will be understood that when an element is referred to as being “on” another element, it can be formed directly on the other element or intervening elements may be present. In the drawings, the shapes and the thicknesses of regions are exaggerated for clarity.

In addition, it will be also understood that although the terms first, second, third, etc. may be used herein to describe various elements, these elements should not be limited by these terms. These terms are only used to distinguish one element from another element. Thus, a first element in some embodiments may be termed a second element in other embodiments without departing from the teachings of the present invention. Embodiments explained and illustrated herein include their complementary counterparts. As used herein, the term “and/or” includes any and all combinations of one or more of the associated listed elements.

The singular expression also includes the plural meaning as long as it does not differently mean in the context. In addition, the terms “comprise”, “have” etc., of the description are used to indicate that there are features, numbers, steps, elements, or combinations thereof, and they should not exclude the possibilities of combination or addition of one or more features, numbers, operations, elements, or a combination thereof. Furthermore, it will be understood that when an element is referred to as being “connected” or “coupled” to another element, it may be directly connected or coupled to the other element or intervening elements may be present.

In addition, the terms “ . . . part,” “ . . . or/er,” “module”, and the like used herein indicate a unit for processing at least one function or operation, which may be implemented by hardware, software, or a combination thereof.

In addition, when detailed descriptions of related known functions or constitutions are considered to unnecessarily cloud the gist of the present invention in describing the present invention below, the detailed descriptions will not be included.

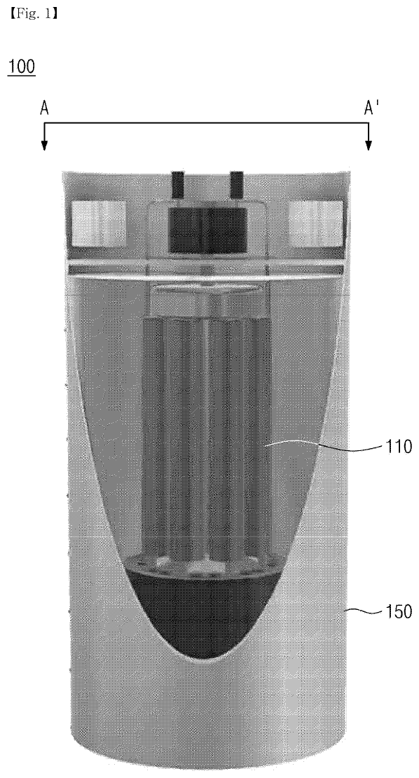

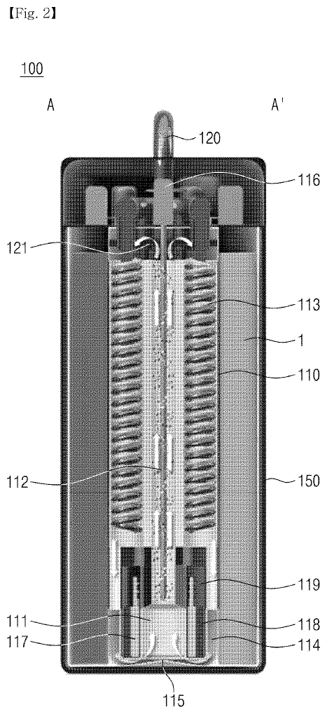

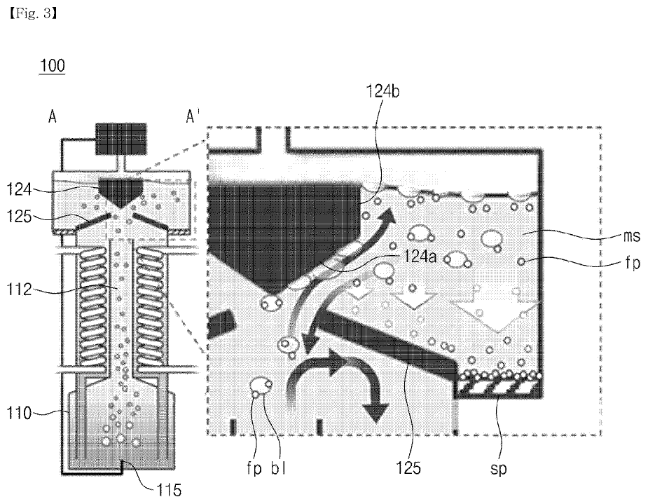

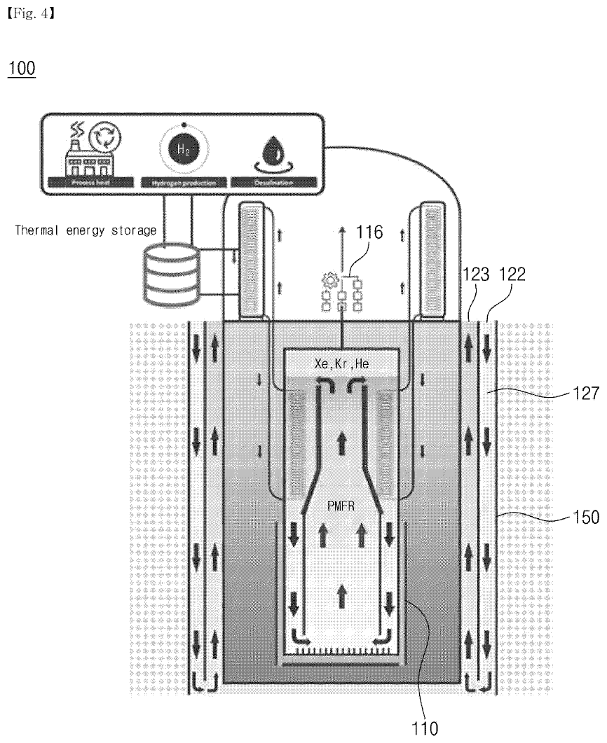

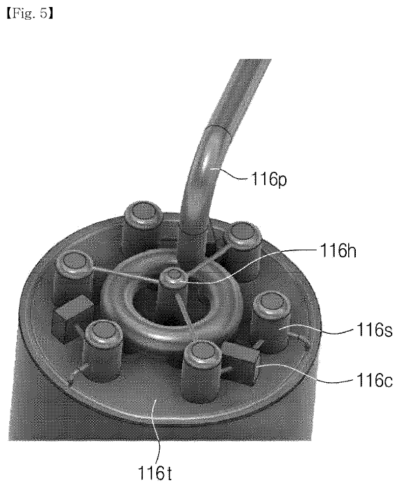

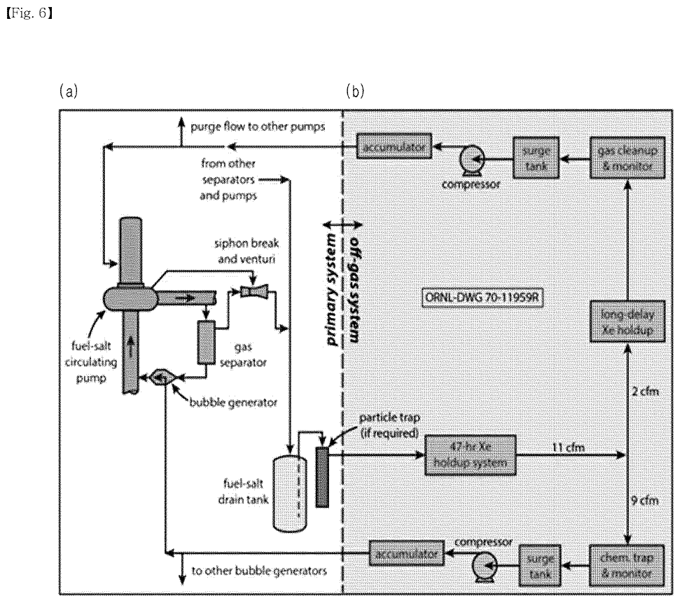

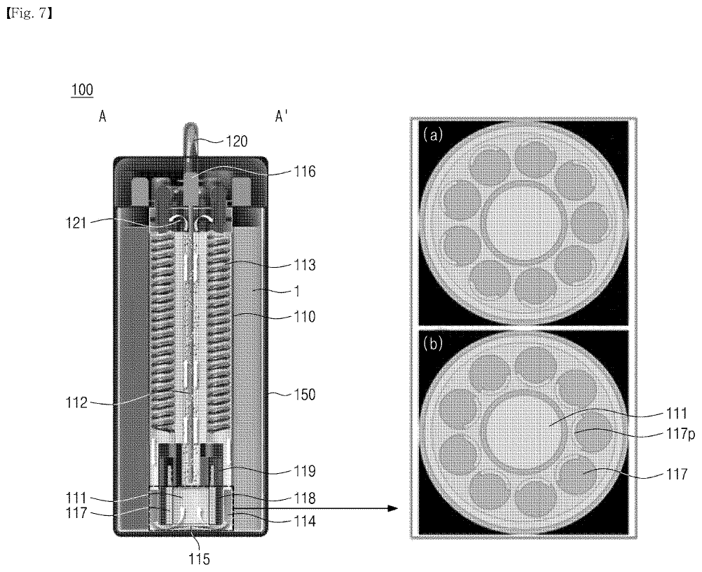

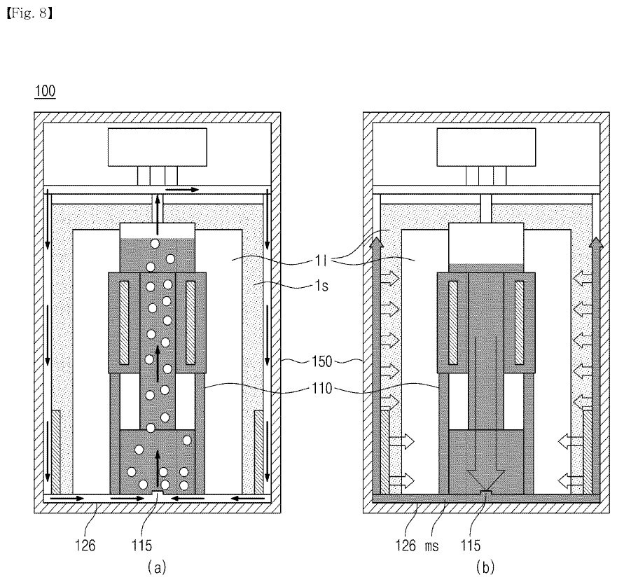

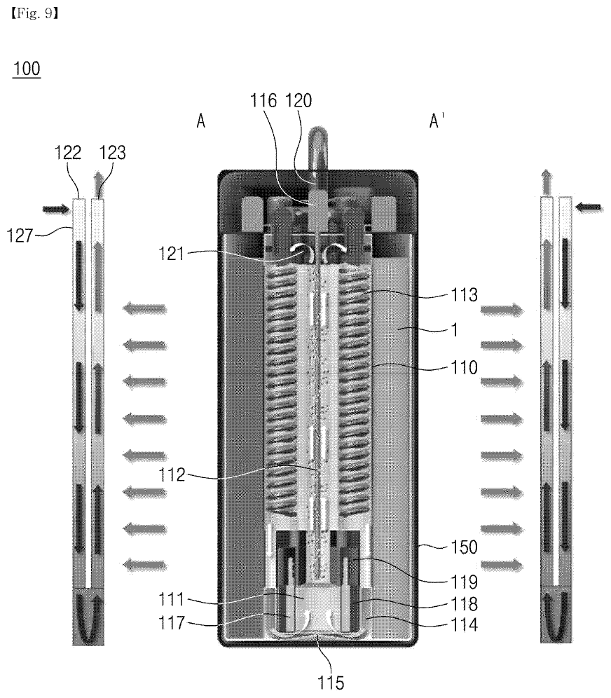

FIG. 1 is a view for explaining a molten salt reactor according to an embodiment of the present application, FIG. 2 is a view for explaining in more detail the molten salt reactor according to the embodiment of the present application, FIG. 3 is a view for explaining a helium injector of the molten salt reactor according to the embodiment of the present application, FIG. 4 is a view for explaining an off-gas system in the molten salt reactor according to the embodiment of the present invention, FIG. 5 is a view for explaining in more detail the off-gas system according to the embodiment of the present application, FIG. 6 is a view for explaining a comparison between the off-gas system and a conventional system according to the embodiment of the present application, FIG. 7 is a view for explaining a drum-type reactivity controller according to the embodiment of the present application, FIG. 8 is a view for explaining an inert salt of the molten salt reactor according to the embodiment of the present application, and FIG. 9 is a view for explaining an inlet and an outlet of the molten salt reactor according to the embodiment of the present application.

Referring to FIG. 1, a molten salt reactor 100 may include a reactor vessel 110.

According to one embodiment, an upper portion of the reactor vessel 110 may be provided in an assembly type for separation, mounting, installation, inspection, or replacement.

In addition, the reactor vessel 110 may include a reactor system provided therein. More specifically, referring to FIG. 2, the reactor system may include at least one unit of a reactor core 111, a riser 112, a high-temperature side of the intermediate heat exchanger 113 (intermediate heat exchanger high-temperature side), a downcomer 114, a helium injector 115, an off-gas system 116, or a drum-type reactivity controller 117. Meanwhile, the reactor system may be transported for each unit and assembled at a site.

According to one embodiment, the reactor core 111 may be provided on a lower portion of the reactor vessel 110, and fission may occur in the reactor core 111 by a fast neutron spectrum. Thus, heat may be generated in the reactor core 111. According to the present application, the reactor core 111 may have a long lifespan with a long term of 20 years or longer without online-reprocessing and without addition of additional nuclear fuel during an operation.

According to one embodiment, the riser 112 may extend upward from the lower portion of the reactor vessel 110. Thus, helium or a molten salt may flow upward along the riser 112.

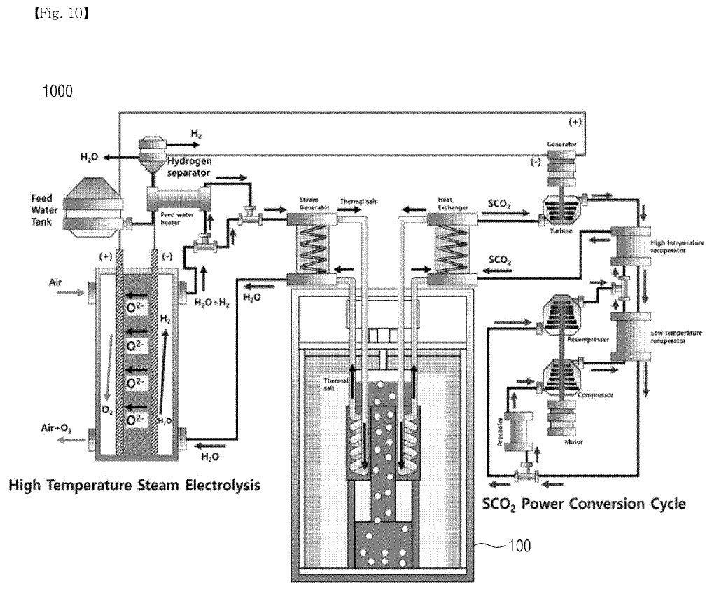

According to one embodiment, the intermediate heat exchanger 113 may be provided in an assembly type for separation, mounting, installation, inspection, or replacement. As shown in FIG. 2, the intermediate heat exchanger 113 may be a shell and helical-coil tube heat exchanger or a printed circuit heat exchanger. However, the present invention is not limited thereto. Meanwhile, the reactor vessel 110 may include the high-temperature side of the intermediate heat exchanger 113, and a reactor system 1000 (see FIG. 10) including the reactor vessel 110 may include a lower-side of the intermediate heat exchanger 113 (intermediate heat exchanger low-temperature side). Accordingly, heat may be transferred from the high-temperature side of the intermediate heat exchanger 113 of the reactor vessel 110 to the low-temperature side of the intermediate heat exchanger 113 of the reactor system 1000.

According to the present application, in the molten salt reactor 100, a nuclear fuel may flow in the reactor system together with a coolant. According to the present application, a neutron reflector is installed on the reactor core 111 to cause a fission reaction mainly in a region of the reactor core 111, thereby providing thermal energy to the molten salt. The molten salt heated by the supply of thermal energy has a relatively low density, and thus buoyancy may act upward, and accordingly, may move upward. The intermediate heat exchanger 113 may be located higher than the reactor core 111 from a bottom surface of the molten salt reactor 100. Accordingly, the heated molten salt may be cooled while flowing in a shell side of the intermediate heat exchanger 113 in the region of the reactor core 111. The molten salt cooled at the shell side of the intermediate heat exchanger 113 may have a relatively high density, and accordingly, may move downward. Therefore, according to the present application, a flow may be formed by natural circulation. That is, according to the present application, circulation may be performed through the above-described natural circulation even though the reactor system does not include a circulation pump. In this case, a temperature of an inlet and an outlet of the reactor core 111 and an inlet and an outlet of the intermediate heat exchanger 113 may be maintained within 600° C. to 800° C.

According to one embodiment, the downcomer 114 may extend from the upper portion to the lower portion of the reactor vessel 110. Thus, the helium or molten salt may flow downward along the downcomer 114.

According to one embodiment, the helium injector 115 may be provided on the lower portion of the reactor vessel 110 or on the riser 112. Accordingly, helium may be injected into the reactor vessel 110 through the helium injector 115. The helium injector 115 may be, for example, in the form of a nozzle, and may be connected to a gas tank in which helium is stored through a fluid line 126 (see FIG. 8). When helium in the gas tank moves through the fluid line 126 and is provided to the lower portion of the reactor vessel 110 or the riser 112 through the helium injector 115, bubbles (bl, see FIG. 3) may be formed inside the reactor vessel 110. More specifically, referring to FIG. 3, the bubbles bl formed through the injected helium may absorb insoluble fission products fp into the reactor vessel 110, for example, gases or noble metals, or adsorb the same on a surface thereof. The bubbles bl that absorb or adsorb the insoluble fission products fp may move to the upper portion of the reactor vessel 110 through the riser 112. The bubbles bl moved to the upper portion of the reactor vessel 110 may burst on a surface of a molten salt ms of the upper portion of the reactor vessel 110. When the bubbles bl burst, the insoluble fission products fp absorbed into or adsorbed onto the bubble bl may fall.

In this case, as shown in FIG. 3, the reactor vessel 110 may include a first guide part 124 and a second guide part 125 provided on the upper portion thereof to guide a movement of the insoluble fission products fp. More specifically, the first guide part 124 may include at least one of a first side wall 124a and a second side wall 124b. More specifically, as shown in FIG. 3, the first side wall 124a may vertically extend upward such that the bubbles bl absorbing or adsorbing the insoluble fission products fp move to an upper side of the second guide part 125. Accordingly, the bubbles bl absorbing or adsorbing the insoluble fission products fp may move to the upper side of the second guide part 125. Meanwhile, as shown in FIG. 3, the second side wall 124b is bent from one end of the first side wall 124a, and when the bubbles bl absorbing or adsorbing the insoluble fission products fp burst while moving to the upper side of the second guide part 125 along the first side wall 124a, the insoluble fission products fp falling from the burst bubbles bl may extend vertically toward the second guide part 125 to move to the upper side of the second guide part 125. Accordingly, when the bubbles bl collecting the insoluble fission products fp rise along the first side wall 124a and burst at the upper side of the second guide part 124b, the insoluble fission products fp falling from the burst bubbles bl may move to the upper side of the second guide part 125 along the second side wall 124b.

In this case, as shown in FIG. 3, the second guide part 125 may extend vertically toward an accommodation space sp accommodating the insoluble fission products fp. Accordingly, the insoluble fission products fp moved to the upper side of the second guide part 125 may move along the second guide part 125 and seated in the accommodation space sp. That is, according to the present application, since the insoluble fission products fp are accommodated in a specific space, there is an effect in that the insoluble fission products fp are easily managed by collecting the same in the specific space.

That is, in the molten salt reactor 100, since the nuclear fuel-coolant molten salt is in a eutectic mixture state, products generated by fission or other nuclear reactions may exist in the molten salt, and the products may flow in the reactor system. Among them, an insoluble fission product, which is not dissolved but exists in a gas or solid state, may cause nuclear-physical instability. In addition, the insoluble fission product may degrade hydrothermal performance and material integrity. However, according to the embodiment of the present application, as described above, as helium is injected through the helium injector 115, bubbles may be formed inside the reactor vessel 110. The bubbles may be grown by absorbing gas-phase fission products, and may help escape from the reactor system. In addition, the bubbles may adsorb solid-phase fission products existing on a nano-micro scale at a boundary surface of the bubbles and physically move the solid-phase fission products to a position that does not affect a fission reaction, a hydrothermal behavior, and a material of the reactor system. Accordingly, according to the present application, the insoluble fission products may be easily collected, and the molten salt reactor 100 may be operated while the insoluble fission products are maintained at a predetermined level or less through the above-described method.

Meanwhile, according to one embodiment, the circulation and reactivity of the reactor system may be controlled by using the injection amount of helium provided by the helium injector 115 as a control variable. More specifically, the control of the circulation and reactivity of the reactor system may maintain the injection amount of helium provided by the helium injector 115 to increase or decrease for a predetermined period of time. Accordingly, the molten salt reactor 100 may be stably operated.

More specifically, according to the present application, the injection of helium to remove the insoluble fission products in the reactor system of the molten salt reactor 100 may cause a heat flow environment by single-phase natural circulation and a heat flow environment by two-phase natural circulation. When helium is injected, helium may receive large buoyancy and quickly rise upward due to a large density difference between helium and molten salt, which is a working fluid. Helium may be heated by ambient molten salt while rising, and a pressure may decrease with a head of the molten salt. Meanwhile, the rising helium may continuously rise while growing as the helium absorbs the gas-phase insoluble fission products. However, the rising helium may undergo a pressure drop due to friction with the molten salt, which may result in transferring momentum to the molten salt. Accordingly, the circulation in the reactor system may increase. According to the present application, as described above, the circulation may be formed by buoyancy that acts according to the density difference based on the temperature change of the molten salt and the density difference between helium and the molten salt. Meanwhile, the buoyancy may vary depending on the control of the injection amount of helium. This may be because the fission reaction is greatly affected by hydrothermal conditions in the reactor system. In other words, the heat flow and the nuclear-physical control may be adjusted by controlling the injection amount of helium provided by the helium injector 115.

According to one embodiment, the off-gas system 116 may be provided on the upper portion of the reactor vessel 110, as shown in FIG. 4. Accordingly, helium in the reactor vessel 110 may be discharged to the outside through the off-gas system 116. More specifically, referring to FIG. 5, the off-gas system 116 may include at least one of a long-delay holdup tank 116t, a compressor 116c, a surge tank 116s, a holdup tank 116h, or an inlet and outlet line 116p.

Referring to FIG. 6, a gas discharge system included in a conventional reactor may not include the long-delay holdup tank 116t, the compressor 116c, the surge tank 116s, the holdup tank 116h, or the inlet and outlet line 116p described above, as shown in FIG. 6(a). Thus, in the conventional reactor, gas discharge inside the reactor vessel may be non-smooth.

However, according to the embodiment of the present application, as shown in FIGS. 5 and 6(b), the off-gas system 116 may include the long-delay holdup tank 116t, the compressor 116c, the surge tank 116s, the holdup tank 116h, or the inlet and outlet line 116p. Accordingly, the off-gas system 116 may discharge at least one of helium, gas, and volatile fission products injected through the helium injector 115.

According to one embodiment, as shown in FIG. 7, the drum-type reactivity controller 117 may be provided inside the reactor system and outside the reactor core 111. Thus, the drum-type reactivity controller 117 may control the circulation and reactivity of the reactor system without interfering with the flow in the reactor core 111 and the riser 112. Meanwhile, the drum-type reactivity controller 117 may be operated in a way of passively or actively suppressing fission according to power interruption. In other words, the circulation and reactivity of the reactor system may be controlled by using the rotation of the drum-type reactivity controller 117 as a control variable. More specifically, referring to FIGS. 7(a) and 7(b), the control of the circulation and reactivity of the reactor system may include rotating at least some of absorber pads 117p of the drum-type reactivity controller 117 such that the absorber pads 117b are directed toward the reactor core 111. Accordingly, the molten salt reactor 100 may be stably operated.

More specifically, during a normal operation, the absorber pad 117p is rotated to be located far from the reactor core 111, and in an accident situation, for example, when the reactor is stopped, the absorber pad 117p may be rotated to be located close to the reactor core 111. Accordingly, the nuclear reaction in the reactor core 111 may be controlled. That is, according to the embodiment of the present application, when the reactor is suddenly stopped, the reactor core output corresponding to a commercial light water reactor may be rapidly reduced, that is, the reactor core output may be reduced to less than 7% within 10 seconds, by reducing the output of the reactor core 111.

Meanwhile, according to one embodiment, as shown in FIG. 2, the reactor system may further include at least one unit of a neutron absorber 118, a control rod drive mechanism (CRDM) compartment 119, a secondary system pipe 120, or a separator 121.

Referring back to FIG. 1, the molten salt reactor 100 may further include a containment vessel 150 surrounding the reactor vessel 110. In addition, referring to FIG. 2, the molten salt reactor 100 may include an inert salt 1 provided outside the reactor vessel 110 and inside the containment vessel 150. According to the embodiment of the present application, the inert salt 1 may be in a liquid phase or a solid phase. The containment vessel 150 may have an internal temperature that gradually decrease in a direction radially away from the center thereof. That is, a temperature of the containment vessel 150 side of the molten salt reactor 100 may be lower than a temperature of the reactor vessel 110 side. Accordingly, the inert salt 1 in the containment vessel 150 may form a thermally insulating solid layer is on an inner wall of the containment vessel 150 as shown in FIG. 8(a). That is, referring to FIG. 8(a), the inert salt 1 may form a liquid layer 1l when the inert salt 1 is adjacent to the reactor vessel 110, and may form a solid layer is when the inert salt 1 is adjacent to the containment vessel 150.

Meanwhile, according to the embodiment of the present application, the molten salt reactor 100 may further include the fluid line 126 surrounding the solid layer is outside the reactor vessel 110 and inside the containment vessel 150, as shown in FIG. 8(a).

Helium, which is injected into the reactor vessel 110 through the helium injector 115 described above, may flow through the fluid line 126 during a normal operation of the molten salt reactor 100. Accordingly, the solid layer is may be formed on the inner wall of the containment vessel 150. On the other hand, when an accident occurs in the molten salt reactor 100, the helium supply may be stopped, and the flow of helium may be blocked in the fluid line 126. Accordingly, an internal pressure of the fluid line 126 may be lower than an internal pressure of the reactor vessel 110. Accordingly, when an accident occurs, molten salt ms inside the reactor vessel 110 may flow into the fluid line 126 through the helium injector 115. As the molten salt ms at a high temperature flows in the fluid line 126, the solid layer is surrounded by the fluid line 126 may be converted into a liquid phase to form a liquid layer 1l as shown in FIG. 8(b). In other words, the solid layer is may undergo a phase transition into the liquid layer 1l in the event of an accident. The solid layer is and the liquid layer 1l have similar thermal conductivity, but the liquid layer 1l may have better heat transfer characteristics than the solid layer is due to a convection phenomenon. That is, according to the present application, the molten salt ms at a high temperature may flow in the fluid line 126 surrounding the solid layer is when an accident occurs as described above, and thus, when the solid layer 1s is converted into the liquid layer 1l, the molten salt reactor 100 may be efficiently cooled through the liquid layer 1l having a better heat transfer characteristic than the solid layer 1s. According to the present application, this may mean that not only a separate device for discharging the molten salt ms inside the reactor vessel 110 to the outside when an accident occurs, but also a separate device for cooling the molten salt reactor 100 when an accident occurs is unnecessary. In other words, the molten salt reactor 100 according to the embodiment of the present application may efficiently respond to an accident without requiring a separate device for preparing for the accident, and thus, a stable operation is possible.

According to one embodiment, the inert salt 1 may dilute a nuclear fuel-coolant salt when the inert salt 1 is discharged from the reactor vessel 110, and may be used in a thermal energy storage device of sodium chloride-magnesium chloride (NaCl—MgCl₂), lithium chloride-potassium chloride (LiCl—KCl), lithium chloride-rubidium chloride (LiCl—RbCl), potassium chloride-magnesium chloride (KCl—MgCl₂), sodium chloride-potassium chloride-magnesium chloride (NaCl—KCl—MgCl₂), lithium chloride-potassium chloride-magnesium chloride (LiCl—KCl—MgCl₂), potassium fluoride-zirconium fluoride (KF—ZrF₄), sodium fluoride-sodium fluoroborate (NaF—NaBF₄), potassium fluoride-potassium fluoride (KF—KBF₄), rubidium fluoride-rubidium fluoride (RbF—RbBF₄), or lithium fluoride-sodium fluoride-potassium fluoride (LiF—NaF—KF).

According to one embodiment, as shown in FIG. 9, the molten salt reactor 100 may further include a flow path 127 having an inlet 122 through which external air is introduced into the containment vessel 150 and an outlet 123 through which the air inside the containment vessel 150 is discharged to the outside. More specifically, as shown in FIG. 4, the flow path 127 may be provided outside the reactor vessel 110 and inside the containment vessel 150. The inlet 122 and the outlet 123 may be closed during a normal operation of the molten salt reactor 100. Accordingly, heat may be easily preserved during the normal operation. On the other hand, when an accident occurs in the molten salt reactor 100, the inlet 122 and the outlet 123 may be passively or actively opened according to power interruption. Meanwhile, the outlet 123 may be located higher than the inlet 122 from a bottom surface of the containment vessel 150. Therefore, according to the present application, the external air may be easily introduced through the inlet 122, and the internal air may be easily discharged through the outlet 123 in the event of an accident. Accordingly, the molten salt reactor 100 may be efficiently cooled.

According to one embodiment, the molten salt reactor 100 may include a structure having corrosion resistance and integrity on a molten salt contact surface inside the reactor vessel 110 and the containment vessel 150.

According to one embodiment, the inside of the reactor vessel 110 may be operated at a low pressure of less than 10 atmospheres.

According to one embodiment, the nuclear fuel provided inside the reactor vessel 110 may be low enriched uranium (LEU) having a uranium-235 enrichment level of less than 20%. Depending on the enrichment level, the fuel may be low enriched uranium having an enrichment level of less than 5% or high assay low enriched uranium (HALEU) having an enrichment level of 5% to less than 20%, as in a general commercial light-water reactor.

According to one embodiment, the working fluid of the reactor system may include the molten salt, and the molten salt may include sodium chloride-uranium trichloride (NaCl—UCl₃), potassium chloride-uranium chloride (KCl—UCl₃), or actinide. In the present application, the actinide may include uranium (U) and plutonium (Pu) together as materials that may be used as fuel by extracting nuclear materials from the nuclear fuel after the actinide is used by pyro-processing or other methods. However, it does not mean that the role or system characteristics change significantly. In addition, according to the embodiment of the present application, an upper space of the reactor vessel 110 in which the molten salt is not present may include a gas that chemically non-reacts with the molten salt. The chemically non-reacting gas may include at least one of helium (He), argon (Ar), krypton (Kr), xenon (Xe), carbon dioxide (CO₂), or nitrogen (N₂).

FIG. 10 is a view for explaining a molten salt reactor system according to the embodiment of the present application.

Referring to FIG. 10, the molten salt reactor system 1000 may include the molten salt reactor 100 as described above. In addition, referring to FIG. 10, the molten salt reactor system 1000 may be associated with a high-temperature water electrolysis-based hydrogen production facility and a power production facility.

According to the embodiment of the present application, the molten salt reactor system 1000 may further include a thermal energy storage system that supplies thermal energy by receiving heat from the reactor system. The thermal energy storage system may include an intermediate heat exchanger low-temperature side that receives heat from an intermediate heat exchanger high-temperature side of the reactor system within the reactor vessel, a thermal energy storage tank that stores thermal energy by moving the molten salt heated while passing through the intermediate heat exchanger low-temperature side, and a production heat exchanger that transfers the thermal energy to an application requiring a high-temperature heat source. According to one embodiment, the thermal energy storage system may include an inert salt not including a nuclear material, and may be used in a thermal energy storage device of sodium chloride-magnesium chloride (NaCl—MgCl₂), lithium chloride-potassium chloride (LiCl—KCl), lithium chloride-rubidium chloride (LiCl—RbCl), potassium chloride-magnesium chloride (KCl—MgCl₂), sodium chloride-potassium chloride-magnesium chloride (NaCl—KCl—MgCl₂), lithium chloride-potassium chloride-magnesium chloride (LiCl—KCl—MgCl₂), potassium fluoride-zirconium fluoride (KF—ZrF₄), sodium fluoride-sodium fluoroborate (NaF—NaBF₄), potassium fluoride-potassium fluoride (KF—KBF₄), rubidium fluoride-rubidium fluoride (RbF—RbBF₄), or lithium fluoride-sodium fluoride-potassium fluoride (LiF—NaF—KF).

According to one embodiment, the intermediate heat exchanger low-temperature side may receive heat from the high-temperature side of the intermediate heat exchanger 113 of the reactor system inside the reactor vessel 110, and the molten salt heated while passing through the intermediate heat exchanger low-temperature side may be moved to store thermal energy in the thermal energy storage tank, and the flow in the thermal energy storage system may be adjusted according to energy demand, and the thermal energy may be supplied from the thermal energy storage system to the production system through the production heat exchanger.

According to one embodiment, the production heat exchanger may include transferring heat to an application including power production, district heating, seawater desalination, hydrogen production, or a process heat source requiring a high-temperature heat source, and one or more production facilities of the application may be installed in a site.

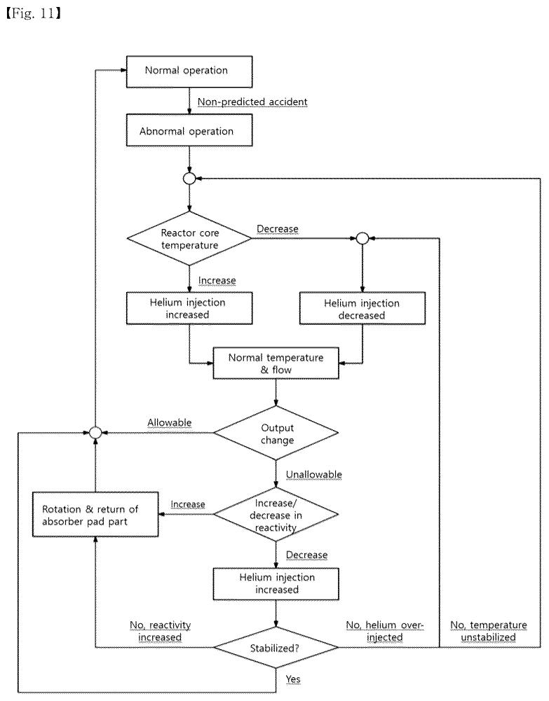

FIG. 11 is a view for explaining a control method of the molten salt reactor system according to the embodiment of the present application.

Referring to FIG. 11, when the reactor system 1000 becomes unstable due to a non-predicted accident, that is, a unpredictable change during the operation of the molten salt reactor 100, a temperature change of a neutron flux may be measured. For example, when the temperature is measured to increase, the non-predicted accident may be a situation involving an increase in the temperature of the reactor core 111. When the temperature of the reactor core 111 increases, a flow rate in the reactor vessel 110 may also decrease. Thus, a fission reaction may be reduced. However, according to the embodiment of the present application, it is possible to quickly recover the fission reduction as described above by increasing the flow rate in the reactor vessel 110. More specifically, according to the embodiment of the present application, as shown in FIG. 11, a first response may be performed when the reaction is not allowable, that is, a reaction exceeds an allowable range, and it may be determined whether an output change is allowable while adjusting the temperature to a normal level through a second response when the reaction is allowable, that is, a reaction is less than the allowable range.

The first response may include controlling circulation and reactivity of the reactor system by using rotation of the drum-type reactivity controller 117 described above as a control variable. More specifically, the control of circulation and reactivity of the reactor system may include rotating at least some of absorber pads 117p of the drum-type reactivity controller 117 such that the absorber pads 117p are directed toward the reactor core 111, as previously described with reference to FIG. 7. Accordingly, the molten salt reactor 100 may be stably operated.

The second response may include controlling circulation and reactivity of the reactor system by using an injection amount of helium provided by the helium injector 115 described above as a control variable. More specifically, the control of the circulation and reactivity of the reactor system may maintain the injection amount of helium provided by the helium injector 115 to increase or decrease for a predetermined period of time. Accordingly, the molten salt reactor 100 may be stably operated.

That is, according to the present application, when a temperature of a primary system working fluid increases, since a density of the nuclear fuel decreases, which leads to a decrease in the reactivity, and the output of the reactor core 111 may also decrease as the reactivity decreases. Accordingly, the temperature of the molten salt reactor 100 may decrease. On the other hand, as the temperature of the working fluid decreases, the density of the nuclear fuel increases, which leads to an increase in the reactivity, and the output of the reactor core 111 may also increase as the reactivity increases. Accordingly, the temperature of the molten salt reactor 100 may increase again. This is an inherent characteristic of a molten salt reactor capable of helping a stable operation, but according to the present application, since an unstable state may be maintained for a long time in a reactor system that does not include a pump or an abnormal operation (abnormal state) may occur before the flow and reactivity are stabilized according to the characteristics, a stable operation of shortening the duration of the unstable state may be required. Accordingly, in the present application, the flow and reactivity for a stable operation may be controlled by adjusting the injection amount of helium in the reactor core 111 or the riser 112 and adjusting the rotation of the drum-type reactivity controller 117. In addition, according to the present application, by providing the thermal energy storage system as shown in FIG. 10, it is possible to compensate for some of the output changes, for example, low or high output changes, which are not constant for a very short time during the control process. That is, as described above with reference to FIG. 11, when an unstable state is generated due to a change that is difficult to predict during the stable operation, the change may be confirmed through the measurement in the reactor core 111. In addition, the unstable state may be confirmed by measuring the inlet and outlet temperature of a steam generator and the neuron flux. According to the present application, as described above, as the temperature of the reactor core 111 increases and/or decreases, the injection amount of helium may increase and/or decrease, and accordingly, the temperature and flow rate of the working fluid may be adjusted to an appropriate level of the operation. Therefore, according to the present application, it is possible to respond faster than a change due to the inherent characteristic according to the temperature change. The change in output for a short period of time may be handled by the heat storage system (secondary system), but when a time to reach stabilization is insufficient, the molten salt reactor 100 may be stabilized through some rotation of the drum-type reactivity controller 117 or an increase in injection amount of helium or time extension through the helium injector 115. According to the present application, the above-described process may be repeatedly performed, and the molten salt reactor 100 may be operated while maintaining a stable state.

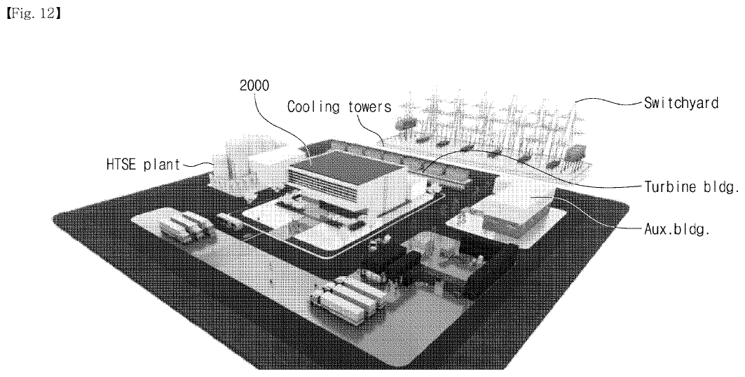

FIG. 12 is a view for explaining a molten salt reactor structure according to the embodiment of the present application.

A molten salt reactor structure 2000 may include the molten salt reactor 100. According to one embodiment, in the molten salt reactor structure 2000, a surrounding environment of the molten salt reactor 100 may be subjected to an ambient pressure or below with an atmospheric atmosphere, and the ambient pressure or below may include non-pressurization. The molten salt reactor structure 2000 may be a building including the molten salt reactor 100.

According to one embodiment, the molten salt reactor structure 2000 may include one or more molten salt reactors 100. In other words, one or more molten salt reactors 100 may be installed in the molten salt reactor structure 2000. In addition, the molten salt reactor structure 2000 may be included in a site environment including a high-temperature water electrolysis-based hydrogen production facility and a power production facility. More specifically, referring to FIG. 12, the molten salt reactor structure 2000 may be associated with at least one of a high-temperature steam electrolysis plant (HTSE), cooling towers, a switchyard, a turbine building (turbine bldg.), or an auxiliary building (aux. bldg.). Accordingly, according to the present invention, there is an effect that a size of the site may be significantly reduced in preparation for productivity compared to existing nuclear facilities.

Hereinafter, an experimental example of the present application will be described.

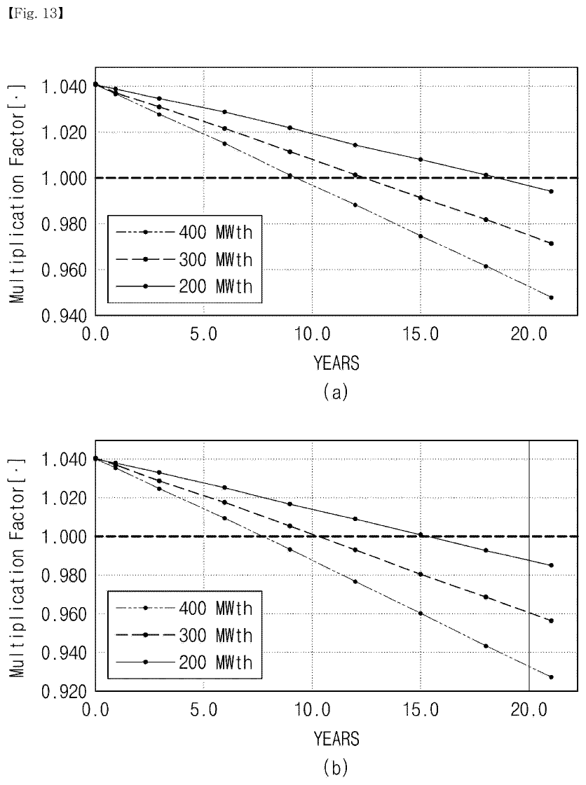

FIG. 13 is a graph of evaluating a long-term and long-lifetime operability of a molten salt reactor by computational analysis according to an experimental example of the present application.

Referring to FIG. 13, a result of evaluating surplus reactivity of the molten salt reactor according to the experimental example of the present application may be observed through Monte-Carlo computer simulation. Through FIG. 13, it can be proved that the molten salt reactor according to the experimental example of the present application may achieve a long-term and long-lifetime operation of 20 years or longer.

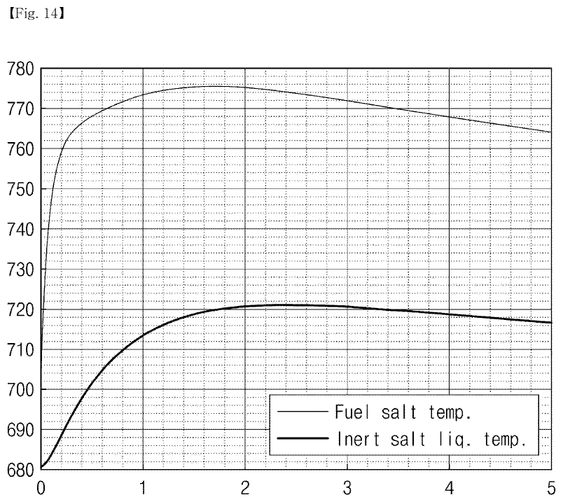

FIG. 14 is a graph of evaluating safety in the event of an accident of the molten salt reactor according to the experimental example of the present application.

Referring to FIG. 14, it is possible to observe a result of evaluating cooling performance by computational analysis of safety in the event of an accident in the molten salt reactor according to the experimental example of the present application. Through FIG. 14, it can be seen that the molten salt reactor according to the experimental example of the present application is maintained at lower than 800° C. even if a separate operation is not performed due to the opening of an external air system that is passively operated in the event of an accident. Therefore, it can be proved that the long-term safety of the molten salt reactor according to the experimental example of the present application may be guaranteed only by air cooling without using external power and AC power.

While the present invention has been described in connection with the embodiments, it is not to be limited thereto but will be defined by the appended claims. In addition, it is to be understood that those skilled in the art may substitute, change, or modify the embodiments in various forms without departing from the scope and spirit of the present invention.

1. A molten salt reactor comprising:
a reactor vessel;
a containment vessel configured to surround the reactor vessel; and
an inert salt provided outside the reactor vessel and inside the containment vessel,
wherein the inert salt is in a liquid phase or a solid phase.

2. The molten salt reactor of claim 1, further comprising a reactor system provided inside the reactor vessel,
wherein the reactor system includes at least one unit of a reactor core, a riser, an intermediate heat exchanger high-temperature side, or a downcomer, and
a heat generation mechanism of the reactor core includes fission performed by a fast neutron spectrum.

3. The molten salt reactor of claim 1, wherein the containment vessel has an internal temperature that gradually decreases in a direction radially away from a center thereof,
the inert salt in the containment vessel forms a thermally insulating solid layer on an inner wall of the containment vessel, and is converted into a liquid phase in an event of an accident, and
the inert salt dilutes a nuclear fuel-coolant salt when the inert salt is discharged from the reactor vessel, and is used in a thermal energy storage device of sodium chloride-magnesium chloride (NaCl—MgCl₂), lithium chloride-potassium chloride (LiCl—KCl), lithium chloride-rubidium chloride (LiCl—RbCl), potassium chloride-magnesium chloride (KCl—MgCl₂), sodium chloride-potassium chloride-magnesium chloride (NaCl—KCl—MgCl₂), lithium chloride-potassium chloride-magnesium chloride (LiCl—KCl—MgCl₂), potassium fluoride-zirconium fluoride (KF—ZrF₄), sodium fluoride-sodium fluoroborate (NaF—NaBF₄), potassium fluoride-potassium fluoride (KF—KBF₄), rubidium fluoride-rubidium fluoride (RbF—RbBF₄), or lithium fluoride-sodium fluoride-potassium fluoride (LiF—NaF—KF).

4. The molten salt reactor of claim 2, further comprising:
a helium injector provided on a lower portion of the reactor vessel or on the riser and configured to inject helium into the reactor vessel; and
an off-gas system provided on an upper portion of the reactor vessel and configured to discharge the helium in the reactor vessel,
wherein the off-gas system discharges at least one of helium, gas, and a volatile fission product injected through the helium injector.

5. The molten salt reactor of claim 2, further comprising a drum-type reactivity controller provided inside the reactor system and outside the reactor core,
wherein the drum-type reactivity controller controls circulation and reactivity of the reactor system without interfering with a flow in the reactor core and the riser, and is operated in a way of passively or actively suppressing fission according to power interruption.

6. The molten salt reactor of claim 4, wherein the circulation and the reactivity of the reactor system are controlled by using an injection amount of the helium provided by the helium injector or rotation of the drum-type reactivity controller as a control variable.

7. The molten salt reactor of claim 6, wherein the control of the circulation and the reactivity of the reactor system includes at least one of:
a first control of rotating at least some of absorber pads of the drum-type reactivity controller such that the absorber pads are directed toward the reactor core; or
a second control of maintaining the injection amount of the helium provided by the helium injector to increase or decrease for a predetermined period of time.

8. The molten salt reactor of claim 2, wherein an upper portion of the reactor vessel or the intermediate heat exchanger is provided in an assembly type for separation, mounting, installation, inspection, or replacement, and
the intermediate heat exchanger is a shell and helical-coil tube heat exchanger or a printed circuit heat exchanger.

9. The molten salt reactor of claim 1, further comprising:
an inlet through which external air is introduced into the containment vessel; and
an outlet through which the air inside the containment vessel is discharged to an outside,
wherein the inlet and the outlet are closed during a normal operation, and are passively or actively opened according to power interruption, and
the outlet is located higher than the inlet from a bottom surface of the containment vessel.

10. The molten salt reactor of claim 1, wherein the molten salt reactor includes a structure having corrosion resistance and integrity, which is provided on a molten salt contact surface between the containment vessel and an inside of the containment vessel,
an inside of the reactor vessel is operated at a low pressure of less than 10 atmospheres, and
a nuclear fuel is provided inside the reactor vessel,
wherein the nuclear fuel includes low enriched uranium (LEU) having a uranium-235 enrichment level of less than 20%.

11. The molten salt reactor of claim 2, wherein a working fluid of the reactor system includes a molten salt,
the molten salt includes sodium chloride-uranium trichloride (NaCl—UCl₃), potassium chloride-uranium chloride (KCl—UCl₃), or actinide,
an upper space of the reactor vessel in which the molten salt is not present includes a gas that chemically non-reacts with the molten salt, and
the chemically non-reacting gas includes at least one of helium (He), argon (Ar), krypton (Kr), xenon (Xe), carbon dioxide (CO₂), or nitrogen (N₂).

12. The molten salt reactor of claim 2, wherein the reactor core has a long lifespan with a long term of 20 years or longer without online-reprocessing and without addition of additional nuclear fuel during an operation.

13. A molten salt reactor system comprising the molten salt reactor of claim 1, wherein the molten salt reactor system further comprises:
a thermal energy storage system configured to supply thermal energy to a production system by receiving heat from a reactor system, and
wherein the thermal energy storage system includes:
an intermediate heat exchanger low-temperature side configured to receive the heat from an intermediate heat exchanger high-temperature side of the reactor system inside the reactor vessel;
a thermal energy storage tank configured to store the thermal energy by moving a molten salt that is heated while passing through the intermediate heat exchanger low-temperature side; and
a production heat exchanger configured to transfer the thermal energy to an application requiring a high-temperature heat source.

14. The molten salt reactor system of claim 13,
wherein the thermal energy storage system includes an inert salt not including a nuclear material,
wherein the inert salt is used in a thermal energy storage device of sodium chloride-magnesium chloride (NaCl—MgCl₂), lithium chloride-potassium chloride (LiCl—KCl), lithium chloride-rubidium chloride (LiCl—RbCl), potassium chloride-magnesium chloride (KCl—MgCl₂), sodium chloride-potassium chloride-magnesium chloride (NaCl—KCl—MgCl₂), lithium chloride-potassium chloride-magnesium chloride (LiCl—KCl—MgCl₂), potassium fluoride-zirconium fluoride (KF—ZrF₄), sodium fluoride-sodium fluoroborate (NaF—NaBF₄), potassium fluoride-potassium fluoride (KF—KBF₄), rubidium fluoride-rubidium fluoride (RbF—RbBF₄), or lithium fluoride-sodium fluoride-potassium fluoride (LiF—NaF—KF),
wherein a flow in the thermal energy storage system is adjusted according to energy demand, and the thermal energy is supplied from the thermal energy storage system to the production system through the production heat exchanger, and
wherein the application includes at least one of power production, district heating, seawater desalination, hydrogen production, or a process heat source, which requires the high-temperature heat source.

15. A molten salt reactor structure comprising the molten salt reactor of claim 1, wherein a surrounding environment of the molten salt reactor is subjected to an ambient pressure or below with an atmospheric atmosphere, and
the ambient pressure or below includes non-pressurization.
